(19) United States
(12) Patent Application Publication
(10) Pub. No.: US 2025/0338240 A1
(43) Pub. Date: Oct. 30, 2025

(54) ALTITUDE- AND SPEED-DEPENDENT NETWORK REGISTRATION

(71) Applicant: T-Mobile USA, Inc., Bellevue, WA (US)

(72) Inventor: Mehul Shah, Bellevue, WA (US)

(21) Appl. No.: 18/646,719

(22) Filed: Apr. 25, 2024

(51) Int. Cl. H04W 60/04; H04W 64/00; H04W 84/04; H04W 84/06

(52) U.S. Cl. CPC H04W 60/04; H04W 64/006; H04W 84/042; H04W 84/06

(57) ABSTRACT

A system of a wireless device for managing network registration procedure based on the device's altitude and speed is disclosed herein. The wireless device includes an altitude sensor to measure the device's altitude and a speed sensor to measure the device's speed of travel. The wireless device identifies, by a Public Land Mobile Network (PLMN) identifier, at least one telecommunications network available for connecting at a current location and initiates a network registration procedure with the telecommunications network when the altitude of the wireless device is less than or equal to an altitude threshold, the speed of the wireless device is less than or equal to a speed threshold, or both. When the altitude of the wireless device is greater than the altitude threshold, the speed of the wireless device is greater than the speed threshold, or both, the wireless device is prevented from initiating the network registration procedure.

### BACKGROUND

The network registration process is initiated when a wireless device wants to associate with a specific network to avail of communication services such as voice, data, and messaging. The wireless device scans for available networks and once a suitable and allowed network is available, the device initiates the registration process, such as an Attach request, which includes authentication and public data network connectivity procedures. Criteria for suitable and allowed networks can include the home network as identified by the Mobile Country Code (MCC) and Mobile Network Code (MNC) of an International Mobile Subscriber Identity (IMSI) on a Subscriber Identity Module (SIM) card in the device or an equivalent Home Public Land Mobile Network as identified by an eHPLMN field on the SIM card, or a roaming partner network identified by a Public Land Mobile Network (PLMN) code that resides on an Operator Public Land Mobile Network (OPLMN) file on the SIM card. If a plurality of roaming partner networks is available, the device initiates connectivity/registration procedures with a partner network and then the home network may steer roaming to a preferred partner network based on business rules.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates an example of a system in which some aspects of the technology are implemented.

FIG. 4 is a flowchart that illustrates a method for managing initiation of network registration procedure of a wireless device based on altitude and speed.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a system for registering a wireless communication device, or a wireless device for short, with a telecommunications network when the altitude of the wireless device crosses a configurable altitude threshold. The wireless device can initiate registration with the telecommunications network using an Attach procedure. The wireless device includes at least one sensor that measures the altitude of the wireless device. In one implementation, the at least one sensor can measure the altitude of the wireless device above ground level (AGL). In another implementation, the at least one sensor can measure the altitude of the wireless device above a mean sea level (MSL). The sensor can be a barometric sensor that calculates an approximate altitude of the wireless device by measuring atmospheric pressure of the air surrounding the wireless device. In some implementations, the wireless device can include at least one other sensor that measures a speed at which the wireless device is traveling.

In one embodiment, the wireless device initiates a network registration procedure with a telecommunications network only if its altitude is less than an altitude threshold configured by an operator of the telecommunications network. In a localized region of the wireless device, the ground can be assumed to be flat or planar such that distance measurements along the ground can be said to be either along an X-axis or a Y-axis, with the altitude of the wireless device considered as the Z-axis. In another embodiment, the wireless device initiates a network registration procedure with the telecommunications network only if the speed of travel of the wireless device is less than a speed threshold configured by the operator of the telecommunications network. In another embodiment, the wireless device initiates a network registration procedure with a telecommunications network only if its altitude is greater than an altitude threshold and only if the speed of travel of the wireless device is greater than a speed threshold. In yet another embodiment, the wireless device initiates a network registration procedure with a telecommunications network only if its altitude is less than an altitude threshold, the speed of travel of the wireless device is less than a speed threshold, and the wireless device's home network or another preferred network is available for connection.

A network that the wireless device can connect to can be identified by a Public Land Mobile Network (PLMN) identifier of the network. The network's PLMN consists of two parts: a three-digit Mobile Country Code (MCC) and a three-digit Mobile Network Code (MNC). The home network of the wireless device is referred to as the home PLMN (HPLMN). A preferred network of the wireless device can be an equivalent network or a visited network, identified by an equivalent PLMN (EPLMN) identifier or a visited PLMN (VPLMN) identifier respectively. The HPLMN is a PLMN of a telecommunications network to which a user of the telecommunications network subscribes to in the user's home country. The VPLMN is a PLMN of a telecommunications network of a roaming partner of a subscriber's home telecommunications network on which the subscriber may be charged a roaming fee. The EPLMN is a PLMN of a telecommunications network of a business partner of a subscriber's home telecommunications network. The EPLMN appears to the subscriber as its home network and the subscriber is not charged a roaming fee when connected to the EPLMN. Upon identifying a network to connect to, the wireless device registers with the network to receive service by performing a network attach procedure. In an LTE network, the attach procedure performed by the wireless device is an LTE Attach procedure. In a 5G network, the attach procedure performed by the wireless device is a 5G Attach procedure.

In one embodiment where the disclosed technology can be implemented to allow a wireless device to establish a network connection, the wireless device initiates a network registration procedure with the network only if its altitude is less than or equal to an altitude threshold, the speed of travel of the wireless device is less than or equal to a speed threshold, and the wireless device's home PLMN or another preferred PLMN is available for connection. If a suitable network is not found, the wireless device can keep searching for a telecommunications network to connect to by initiating a scan of other networks. One example of the disclosed technology implemented to allow a desired connection is when a drone is allowed to connect to a terrestrial network during a disaster recovery operation. Another example is allowing network registration for subsequent communication between two wireless devices that are located in high-rise buildings, including consumers and fixed assets used for smart city applications. In both these examples, the wireless device is located below an allowable altitude threshold and is stationary or is traveling at a speed below an allowable speed threshold. In such implementations, the logic implemented using the disclosed technology can be summarized as below:

```
If {altitude <= altitude_threshold} AND {device speed <=
speed_threshold}
AND {PLMN = MCC+MNC}
Then
  Initiate registration to network;
Else
  Initiate scan of other networks;
End;
```

In another embodiment where the disclosed technology can be implemented to prevent a wireless device from establishing a network connection, the wireless device is prevented from initiating a network registration procedure with the network if its altitude is greater than altitude threshold, or the speed of travel of the wireless device is greater than a speed threshold, or both. One example of the disclosed technology implemented to prevent an undesired connection is when a wireless device located in an airplane attempts to register with a terrestrial network. In this scenario, the operator of the telecommunications network may want the wireless device to establish connectivity using cheaper alternatives such as an in-flight Wi-Fi network. Another example of the disclosed technology implemented to prevent an undesired connection is when a wireless device, capable of satellite communication, that is located in an airplane attempts to register with a non-terrestrial network such as a satellite network, which may be resource-constrained or expensive to use. In this scenario, the operator of the telecommunications network may want to prevent the wireless device from establishing connectivity with the satellite network and use a cheaper alternative such as an in-flight Wi-Fi network instead. In such implementations, the logic implemented using the disclosed technology can be summarized as below:

If {altitude > altitude_threshold} OR {device speed > speed_threshold}
Then
Don't initiate registration to network;
End;

Likewise, one skilled in the relevant technology will understand that the invention can include any combination of equality or inequality among the aforementioned measurements of a wireless device's altitude and speed of travel relative to their respective thresholds configurable by the operator of the telecommunications network.

In one implementation, the wireless device can include at least one sensor that uses inertial measurements to calculate an approximate speed at which the wireless device is traveling. In another implementation, the wireless device can include at least one sensor that uses a global positioning system (GPS) to calculate an approximate speed at which the wireless device is traveling. In another implementation, the wireless device can include at least one sensor that uses a triangulation of signals from the telecommunications network to calculate an approximate speed at which the wireless device is traveling. In another implementation, the wireless device can include at least one sensor that uses other wireless signals such as Wi-Fi or Bluetooth to calculate an approximate speed at which the wireless device is traveling. In yet another implementation, the wireless device can use any combination of the aforementioned sensors and methods to calculate an approximate altitude of the wireless device and an approximate speed at which the wireless device is traveling. The telecommunications network can be a terrestrial network or a non-terrestrial network.

The wireless device is configured to initiate a network registration procedure with the telecommunications network based on the occurrence of at least one event. In one implementation, the event can be a calculation by at least one sensor on the wireless device that the altitude of the wireless device is greater than a threshold configured by an operator of the telecommunications network. In another implementation, the event can be a calculation by at least one sensor on the wireless device that the altitude of the wireless device is less than a threshold configured by an operator of the telecommunications network. In yet another implementation, the event can be a change in altitude of the wireless device. The change can be an increase or a decrease. In one implementation, the event can be a calculation by at least one sensor on the wireless device that the speed of travel of the wireless device is greater than a threshold configured by an operator of the telecommunications network. In another implementation, the event can be a calculation by at least one sensor on the wireless device that the speed of travel of the wireless device is less than a threshold configured by an operator of the telecommunications network. In yet another implementation, the event can be a change in the speed of travel of the wireless device. The change can be an increase or a decrease. In one implementation, the event can be expiry of a registration timer. In another implementation, the event can be a change in a location of the wireless device. In another implementation, the event can be the reception of a registration message from the telecommunications network. In yet another implementation, the event can be any combination of the aforementioned events.

The wireless device is assigned at least one unique International Mobile Subscriber Identity (IMSI) by a manufacturer of the wireless device. The wireless device can be associated with at least one telecommunications network that serves as a home network of the wireless device. The at least one telecommunications network is uniquely identified by a PLMN identifier which is a combination of at least one MCC comprising at least two digits and at least one MNC comprising at least two digits. The wireless device can include at least one hardware processor and at least one non-transitory, computer-readable storage medium that functions as a Subscriber Identity Module (SIM). In one implementation, the SIM is in the form of a physical SIM card that is removable from the wireless device by a user of the wireless device. The removable physical SIM card can be a mini-SIM card, a micro SIM card, or a nano SIM card. In another implementation, the SIM can be an embedded SIM (eSIM) card, which is a non-removable card that is permanently embedded into the wireless device. In yet another implementation, the SIM can be an integrated SIM (iSIM) which is integrated into at least one hardware processor included in the wireless device. In one implementation, the IMSI can be stored in a SIM associated with the wireless device.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

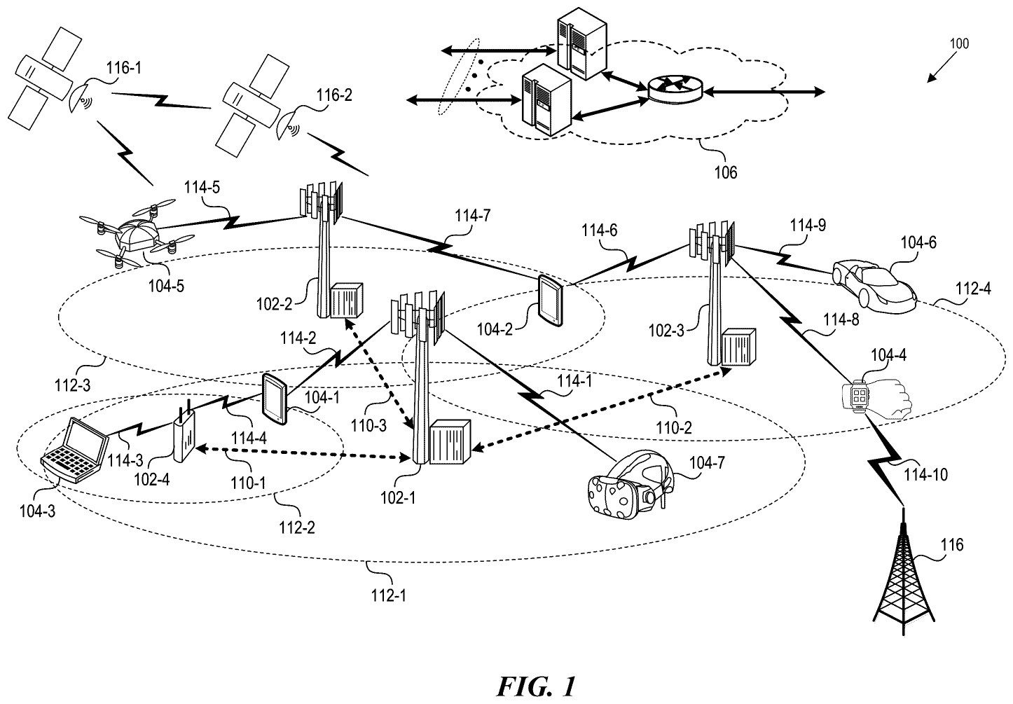

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, a mobile device, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

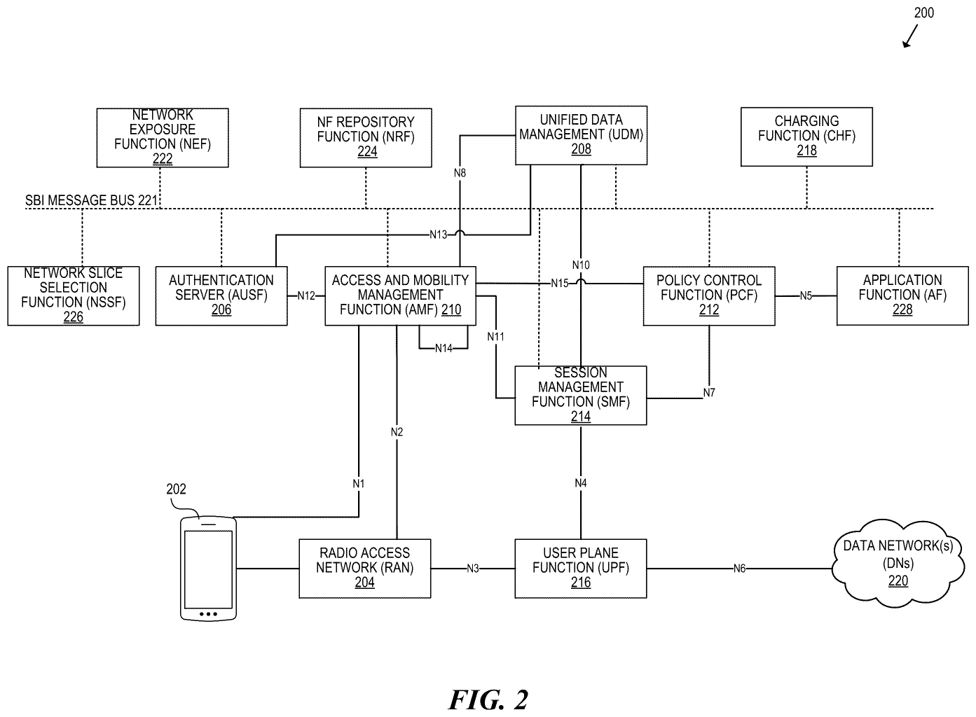

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFS include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### System for Managing Network Registration Based on Altitude and Speed

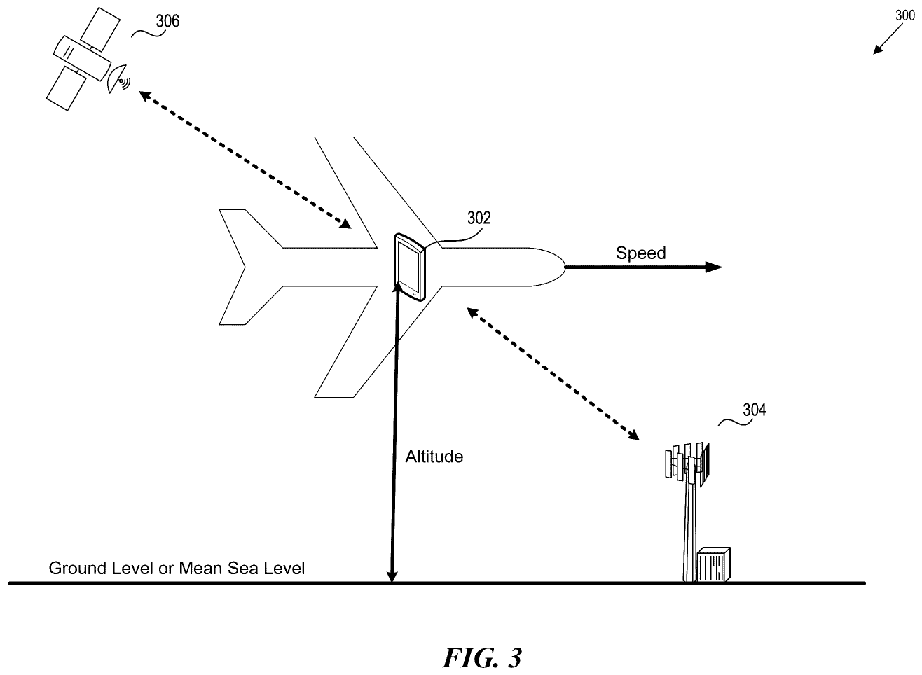

FIG. 3 illustrates an example of a system 300 in which some aspects of the technology are implemented. The wireless device 302 can include at least one altitude sensor to measure a current altitude (i.e. longitudinal position of the wireless device 302 above the earth's surface) of the wireless device 302, and at least one speed sensor to measure a current rate of travel (i.e. speed of travel) of the wireless device 302. In some implementations, the altitude sensor can be configured to measure the altitude of the wireless device 302 above a local ground level (AGL). In some implementations, the altitude sensor can be configured to measure the altitude of the wireless device 302 above a mean sea level (MSL). When some aspects of the disclosed technology are implemented in a system of the wireless device 302, the system can allow the wireless device 302 to initiate a network registration procedure with a terrestrial network 304 only when the altitude of the wireless device 302 is less than or equal to an altitude threshold, when the speed of travel of the wireless device 302 is less than or equal to a speed threshold, or when both aforementioned conditions are met. When some aspects of the disclosed technology are implemented in a system of the wireless device 302, the system can allow the wireless device 302 to initiate a network registration procedure with a non-terrestrial network 306 only when the altitude of the wireless device 302 is less than or equal to an altitude threshold, when the speed of travel of the wireless device 302 is less than or equal to a speed threshold, or when both aforementioned conditions are met. While FIG. 3 is an illustrative example, other combinations for allowing or disallowing the wireless device 302 to initiate network registration procedure with a terrestrial or non-terrestrial network based on a combination of altitude or speed conditions are possible.

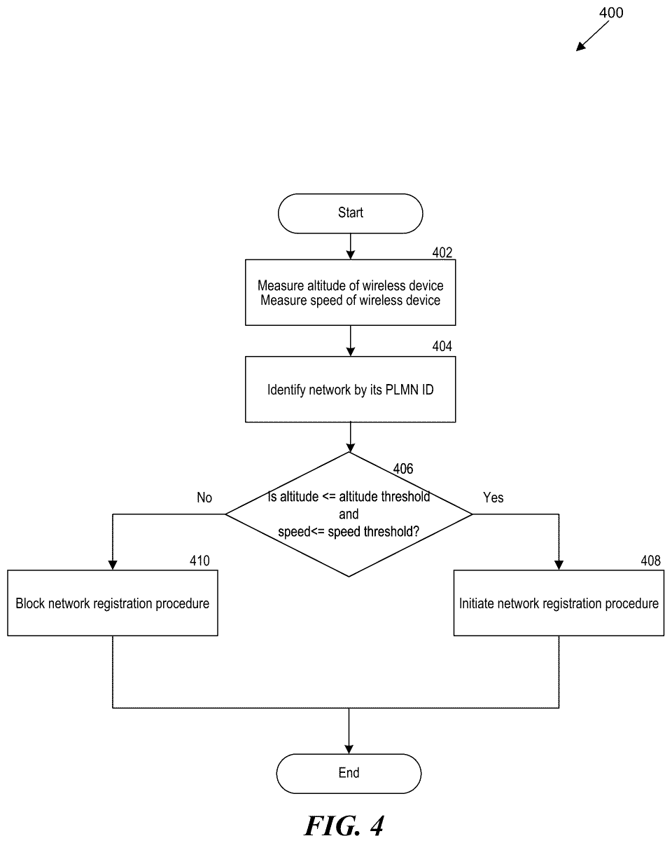

FIG. 4 is a flowchart that illustrates a method 400 for managing initiation of network registration procedure of a wireless device based on altitude and speed. The wireless device comprises at least one hardware processor, at least one sensor for measuring an altitude of the wireless device, at least one sensor for measuring a speed at which the wireless device is traveling, and at least one non-transitory memory storing instructions thereon which, when executed by the at least one hardware processor, cause the system to manage initiation of network registration procedures based on the wireless device's altitude and speed.

At 402, the system measures an altitude of the wireless device and the speed at which the wireless device is traveling. At 404, the system identifies, by a PLMN identifier, at least one telecommunications network available for connecting at a current location of the wireless device. The wireless device identifies the at least one telecommunications network available for connecting at the current location of the wireless communication device by receiving a signal from the telecommunications network at the current location of the wireless device, extracting from the received signal at least one PLMN identifier, and comparing the extracted PLMN identifier with at least one allowable PLMN identifier known to the wireless device. The at least one PLMN identifier comprises at least one MCC and at least one MNC. The PLMN identifier can be a home PLMN (HPLMN) identifier of the wireless device, which identifies a telecommunications network to which a subscriber of the wireless device subscribes to in their home country. The PLMN identifier can be an equivalent PLMN (ePLMN) identifier of the wireless device, which identifies a partner telecommunications network of the telecommunications network of the subscriber of the wireless device and is a network on which the subscriber of the wireless device is not charged a roaming fee when connected to the network. The PLMN identifier can be a visited PLMN (VPLMN) identifier of the wireless device, which identifies a telecommunications network of a roaming partner of the telecommunications network of the subscriber of the wireless device and is a network on which the subscriber of the wireless device is charged a roaming fee when connected.

At 406, the system compares the measured altitude with an altitude threshold and the measured speed with a speed threshold. The system makes a first determination that the measured altitude of the wireless device is less than or equal to an altitude threshold or that the speed of travel of the wireless device is less than or equal to a speed threshold, or both. Alternatively, the system makes a second determination that the measured altitude of the wireless device is greater than the altitude threshold or that the speed of travel of the wireless device is greater than the speed threshold, or both. The altitude threshold can be stored in at least one non-transitory storage medium in the wireless device, from where it is retrieved, or it can be obtained from a message broadcast by the telecommunications network that is received by the wireless device. The speed threshold can be stored in at least one non-transitory storage medium in the wireless device, from where it is retrieved, or it can be obtained from a message broadcast by the telecommunications network that is received by the wireless device. Retrieving the altitude threshold and the speed threshold from the at least one non-transitory storage medium in the wireless device is done prior to the first determination and the second determination. Similarly, obtaining the altitude threshold and the speed threshold from a message broadcast by the telecommunications network that is received by the wireless device is done prior to the first determination and the second determination.

At 408, the system initiates a network registration procedure with the telecommunications network when the altitude of the wireless device is less than or equal to an altitude threshold and the speed of the wireless device is less than or equal to the speed threshold. At 410, when the altitude of the wireless device is greater than the altitude threshold, the speed of travel of the wireless device is greater than the speed threshold, or both, the system prevents the wireless device from initiating a network registration procedure with the telecommunications network. The telecommunications network can be a terrestrial network such as an LTE or 5G network, or a non-terrestrial network such as a satellite network.

### Computer System

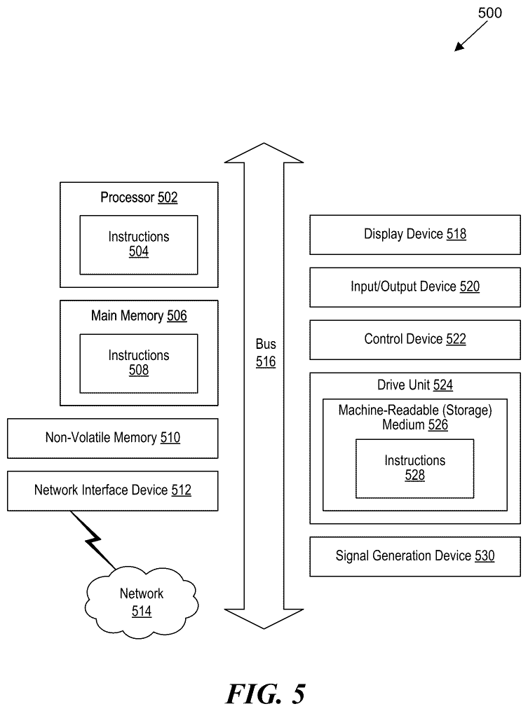

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### REMARKS

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A system of a wireless device comprising:
at least one hardware processor;
at least one altitude sensor configured to measure an altitude of the wireless device;
at least one speed sensor configured to measure a speed of travel of the wireless device; and
at least one non-transitory memory storing instructions, which, when executed by the at least one hardware processor, cause the system to:
receive, at a current location of the wireless device, a signal from a telecommunications network;
extract, from the received signal, at least one Public Land Mobile Network (PLMN) identifier,
wherein the at least one PLMN identifier comprises a Mobile Country Code (MCC) and a Mobile Network Code (MNC);
compare the extracted PLMN identifier with at least one allowable PLMN identifier known to the wireless device;
measure the altitude of the wireless device or the speed of travel of the wireless device;
perform a first determination that the measured altitude of the wireless device is less than or equal to an altitude threshold or that the speed of travel of the wireless device is less than or equal to a speed threshold, or both, or
perform a second determination that the measured altitude of the wireless device is greater than the altitude threshold or that the speed of travel of the wireless device is greater than the speed threshold, or both; and
in response to the first determination that the measured altitude of the wireless device is less than or equal to the altitude threshold or that the speed of travel of the wireless device is less than or equal to the speed threshold, initiate a network registration procedure with the telecommunications network.

2. The system of claim 1 further caused to:
initiate, by the wireless device, the network registration procedure with the telecommunications network in response to the first determination that the measured altitude of the wireless device is less than or equal to the altitude threshold.

3. The system of claim 1 further caused to:
initiate, by the wireless device, the network registration procedure with the telecommunications network in response to the first determination that the measured speed of travel of the wireless device is less than or equal to the speed threshold.

4. The system of claim 1 further caused to:
initiate, by the wireless device, the network registration procedure with the telecommunications network in response to the first determination that the measured altitude of the wireless device is less than or equal to the altitude threshold and the measured speed of travel of the wireless device is less than or equal to the speed threshold.

5. The system of claim 1 further caused to:
prevent the wireless device from initiating a network registration procedure with the telecommunications network in response to the second determination that the altitude of the wireless device is greater than the altitude threshold, the speed of travel of the wireless device is greater than the speed threshold, or both.

6. The system of claim 1 further caused to:
prevent the wireless device from initiating a network registration procedure with the telecommunications network in response to the second determination that the altitude of the wireless device is greater than the altitude threshold, the speed of travel of the wireless device is greater than the speed threshold, or both,
wherein the telecommunications network is a terrestrial network.

7. The system of claim 1 further caused to:
prevent the wireless device from initiating a network registration procedure with the telecommunications network in response to the second determination that the altitude of the wireless device is greater than the altitude threshold, the speed of travel of the wireless device is greater than the speed threshold, or both,
wherein the telecommunications network is a non-terrestrial network (NTN).

8. The system of claim 1,
wherein the at least one PLMN identifier known to the wireless device is a home PLMN (HPLMN) identifier of the wireless device, and
wherein the HPLMN identifier identifies a telecommunications network to which a subscriber of the wireless device subscribes to in their home country.

9. The system of claim 1,
wherein the at least one PLMN identifier known to the wireless device is an equivalent PLMN (ePLMN) identifier of the wireless device,
wherein the ePLMN identifier identifies a partner telecommunications network of the telecommunications network of a subscriber of the wireless device, and
wherein the subscriber of the wireless device is not charged a roaming fee when connected to the partner telecommunications network.

10. The system of claim 1,
wherein the at least one PLMN identifier known to the wireless device is a visited PLMN (VPLMN) identifier of the wireless device,
wherein the VPLMN identifier identifies a telecommunications network of a roaming partner of the telecommunications network of a subscriber of the wireless device, and
wherein the subscriber of the wireless device is charged a roaming fee when connected to the roaming partner telecommunications network.

11. The system of claim 1 further caused to, prior to the first determination and the second determination:
receive a message broadcast by the telecommunications network; and
obtain the altitude threshold from the message broadcast by the telecommunications network.

12. The system of claim 1 further caused to, prior to the first determination and the second determination:
retrieve the altitude threshold from at least one non-transitory storage medium included in the wireless device.

13. The system of claim 1 further caused to, prior to the first determination and the second determination:
receive a message broadcast by the telecommunications network; and
obtain the speed threshold from the message broadcast by the telecommunications network.

14. The system of claim 1 further caused to, prior to the first determination and the second determination:
retrieve the speed threshold from at least one non-transitory storage medium included in the wireless device.

15. A method for managing a network registration procedure between a wireless device and a telecommunications network based on an altitude at which the wireless device is located and a speed of travel of the wireless device, wherein the wireless device includes:
at least one altitude sensor configured to measure an altitude of the wireless device, and
at least one speed sensor configured to measure a speed of travel of the wireless device,
the method comprising:
receiving a signal from the telecommunications network at a current location of the wireless device;
extracting from the received signal at least one Public Land Mobile Network (PLMN) identifier,
wherein the at least one PLMN identifier comprises a Mobile Country Code (MCC) and a Mobile Network Code (MNC);
comparing the extracted PLMN identifier with at least one allowable PLMN identifier known to the wireless device;
measuring the altitude of the wireless device or the speed of travel of the wireless device;
making a first determination that the measured altitude of the wireless device is less than or equal to an altitude threshold or that the speed of travel of the wireless device is less than or equal to a speed threshold, or both, or
making a second determination that the measured altitude of the wireless device is greater than the altitude threshold or that the speed of travel of the wireless device is greater than the speed threshold, or both; and
in response to the first determination that the measured altitude of the wireless device is less than or equal to the altitude threshold and that the speed of travel of the wireless device is less than or equal to the speed threshold, initiating a network registration procedure with the telecommunications network.

16. The method of claim 15 further comprising:
preventing the wireless device from initiating a network registration procedure with the telecommunications network in response to the second determination that the altitude of the wireless device is greater than the altitude threshold, the speed of travel of the wireless device is greater than the speed threshold, or both.

17. The method of claim 15 further comprising:
preventing the wireless device from initiating a network registration procedure in response to the second determination that the altitude of the wireless device is greater than the altitude threshold, the speed of travel of the wireless device is greater than the speed threshold, or both, and the telecommunications network is a non-terrestrial network (NTN).

18. The method of claim 15, wherein the PLMN identifier known to the wireless device is a home PLMN (HPLMN) identifier, an equivalent PLMN (ePLMN) identifier, or a visited PLMN (VPLMN) identifier,
wherein the HPLMN identifier identifies a telecommunications network to which a subscriber of the wireless device subscribes to in their home country,
wherein the ePLMN identifier identifies a partner telecommunications network of the telecommunications network of the subscriber of the wireless device,
wherein the subscriber of the wireless device is not charged a roaming fee when connected to the partner telecommunications network,
wherein the VPLMN identifier identifies a roaming partner telecommunications network of the telecommunications network of the subscriber of the wireless device, and
wherein the subscriber of the wireless device is charged a roaming fee when connected to the roaming partner telecommunications network.

19. The method of claim 15,
wherein the altitude threshold is stored in at least one non-transitory storage medium in the wireless device or is received by the wireless device from a message broadcast by the telecommunications network, and
wherein the speed threshold is stored in at least one non-transitory storage medium in the wireless device or is received by the wireless device from a message broadcast by the telecommunications network.

20. A non-transitory, computer-readable storage medium comprising instructions recorded thereon, wherein the instructions, when executed by at least one data processor of a system of a wireless device, the wireless device including:
at least one altitude sensor configured to measure an altitude of the wireless device, and
at least one speed sensor configured to measure a speed of travel of the wireless device,
cause the system to:
receive, at a current location of the wireless device, a signal from a telecommunications network;
extract, from the received signal, at least one Public Land Mobile Network (PLMN) identifier,
wherein the at least one PLMN identifier comprises a Mobile Country Code (MCC) and a Mobile Network Code (MNC);
compare the extracted PLMN identifier with at least one allowable PLMN identifier known to the wireless device;
measure the altitude of the wireless device or the speed of travel of the wireless device;
determine that the measured altitude of the wireless device is greater than an altitude threshold or that the speed of travel of the wireless device is greater than a speed threshold, or both; and
in response to the determination that the measured altitude of the wireless device is greater than the altitude threshold or that the speed of travel of the wireless device is greater than the speed threshold, or both, prevent the wireless device from initiating a network registration procedure with the telecommunications network.
